(19) United States
(12) Patent Application Publication
(10) Pub. No.: US 2010/0201485 A1
(43) Pub. Date: Aug. 12, 2010

(54) ELECTRONIC APPARATUS WITH HIDDEN BIOMETRICS SENSOR

(76) Inventor: Bruce C.S. CHOU, Hsin chu City (TW)

Correspondence Address: Muncy, Geissler, Olds & Lowe, PLLC, 4000 Legato Road, Suite 310, FAIRFAX, VA, 22033, US

(21) Appl. No.: 12/700,532

(22) Filed: Feb. 4, 2010

(30) Foreign Application Priority Data
Feb. 6, 2009 (TW) 098103791

(51) Int. Cl. G05B 19/00

(52) U.S. Cl. 340/5.83; 382/124

(57) ABSTRACT

An electronic apparatus includes a module and a biometrics sensor. The module has an exposed surface and an unexposed surface. The biometrics sensor has an embedded sensing surface. The embedded sensing surface is joined to the unexposed surface of the module so that a portion of the exposed surface corresponding to a contact portion between the embedded sensing surface and the unexposed surface serves as an exposed sensing surface for sensing biometrics information.

This application claims priority of No. 098103791 filed in Taiwan R.O.C. on Feb. 6, 2009 under 35 USC 119, the entire content of which is hereby incorporated by reference.

### BACKGROUND OF THE INVENTION

1. Field of the Invention

The invention relates to an electronic apparatus with a hidden biometrics sensor.

2. Related Art

Conventional biometrics sensors, such as fingerprint sensors, have been widely used in various electronic apparatuses for the authentication of the biometrics information. For example, a notebook computer and a mobile telephone may be equipped with the fingerprint sensors so that the user can perform the authentication function.

When the conventional fingerprint sensor is mounted on a mobile telephone, for example, the casing of the mobile telephone has to be formed with an opening for exposing the fingerprint sensor. Such a design has the following drawbacks. First, the structure of the casing is complicated. Second, the overall outlook and ID cosmetics of the mobile telephone is degraded. Third, the exposed fingerprint sensor tends to be damaged by the impact and the electrostatic discharge. Fourth, the contamination is left in the gap between the fingerprint sensor and the opening of the casing.

### SUMMARY OF THE INVENTION

It is therefore an object of the invention to provide an electronic apparatus with a hidden biometrics sensor so that the design of the casing is simple and the good ID outlook of the casing without opening may be maintained. In addition, the biometrics sensor is free from being damaged by the impact and the electrostatic discharge, and it is possible to prevent the contamination from being left in the opening gap as the traditional design does.

The invention achieves the above-identified object by providing an electronic apparatus including a module and a biometrics sensor. The module has an exposed surface and an unexposed surface. The biometrics sensor has an embedded sensing surface joined to the unexposed surface of the module so that a portion of the exposed surface corresponding to a contact portion between the embedded sensing surface and the unexposed surface serves as an exposed sensing surface for sensing biometrics information.

Thus, the electronic apparatus with the hidden biometrics sensor according to the invention can simplify the structure of the casing of the electronic apparatus so that the overall electronic apparatus has the good ID outlook. In addition, the biometrics sensor is no longer exposed outside, and cannot be easily damaged by the impact and the electrostatic discharge. Furthermore, no exposed gap is formed between the biometrics sensor and the casing so that the contamination cannot be left in the gap.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a top view showing an electronic apparatus having a hidden biometrics sensor according to a first embodiment of the invention.

FIG. 2 is a cross-sectional view taken along a line 2-2 of FIG. 1.

FIG. 3 shows a modification of FIG. 2.

FIG. 4 is a top view showing an electronic apparatus with a hidden biometrics sensor according to a second embodiment of the invention.

FIG. 5 is a cross-sectional view taken along a line 5-5 of FIG. 4.

FIG. 6 is a rear view showing an electronic apparatus having a hidden biometrics sensor according to a third embodiment of the invention.

FIG. 7 shows another modification of FIG. 2.

FIG. 8 is a rear view showing an electronic apparatus having a hidden biometrics sensor according to a fourth embodiment of the invention.

FIGS. 9 and 10 show other modifications of FIG. 2.

FIG. 11 is a cross-sectional view, similar to FIG. 5, showing an electronic apparatus having a hidden biometrics sensor according to a fifth embodiment of the invention.

FIG. 12 is a cross-sectional view, similar to FIG. 5, showing an electronic apparatus having a hidden biometrics sensor according to a sixth embodiment of the invention.

### DETAILED DESCRIPTION OF THE INVENTION

The present invention will be apparent from the following detailed description, which proceeds with reference to the accompanying drawings, wherein the same references relate to the same elements.

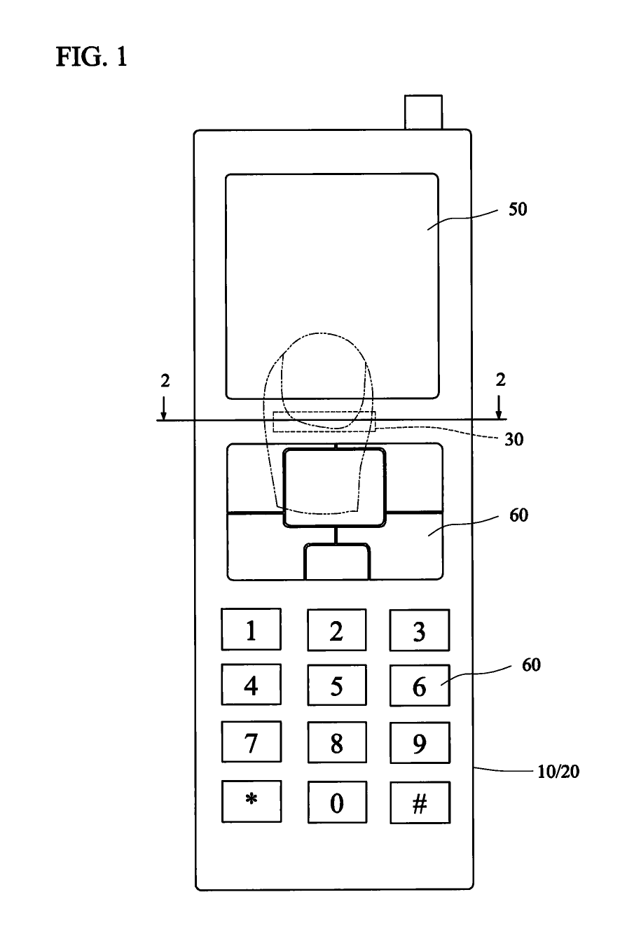

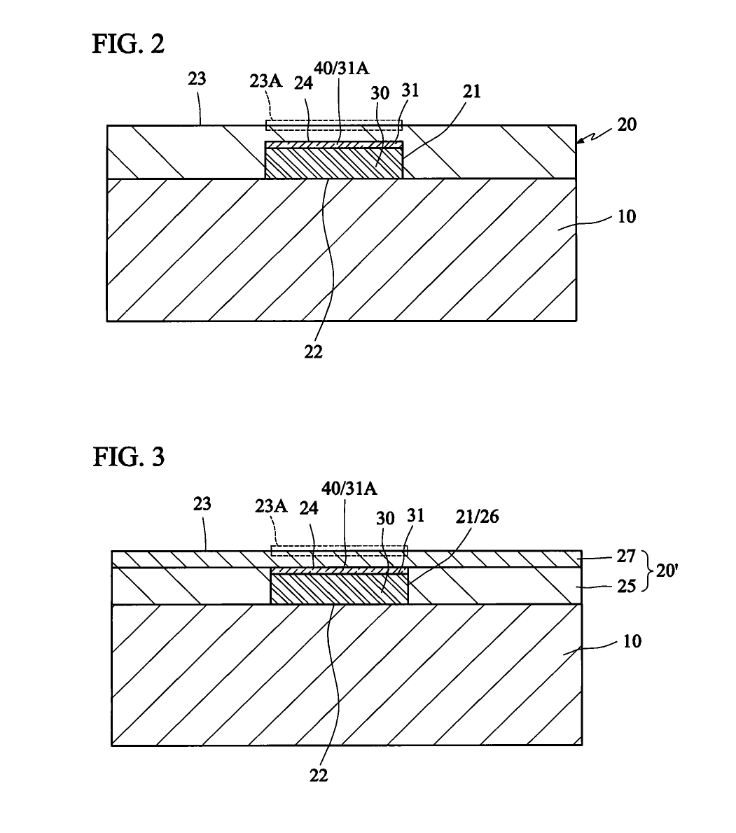

FIG. 1 is a top view showing an electronic apparatus having a hidden biometrics sensor according to a first embodiment of the invention. FIG. 2 is a cross-sectional view taken along a line 2-2 of FIG. 1. Referring to FIGS. 1 and 2, the electronic apparatus of this embodiment includes a module 20 and a biometrics sensor 30. In addition, the electronic apparatus may further include a body 10. In this embodiment, the electronic apparatus is a mobile apparatus, such as a mobile telephone. In other embodiments, the electronic apparatus may be a personal digital assistant, a notebook computer or any other electronic apparatus.

The module 20 having an exposed surface 23 and an unexposed surface 24 mounted on the body 10. In this embodiment, the module 20 is a front cover. The exposed surface 23 is a fully flat surface or a substantially flat surface so that the finger of the user can smoothly slide thereon.

The biometrics sensor 30 includes, without limitation to, a fingerprint sensor. The biometrics sensor senses the unique biometrics characteristic of the human body, such as the textures of the finger surface, the shape of the hypodermic vein under the finger skin, or the hypodermic substance under the finger skin, such as heme, blood oxygen concentration or other biometrics information. The biometrics sensor 30 has an embedded sensing surface 31 joined to the unexposed surface 24 of the module 20 so that a portion of the exposed surface 23 corresponding to a contact portion 31A between the embedded sensing surface 31 and the unexposed surface 24 serves as an exposed sensing surface 23A for sensing the biometrics information.

In this embodiment, the module 20 is a one-piece molded cover. The module 20 further has a slot 21. One opening 22 of the slot 21 is disposed opposite the body 10. The unexposed surface 24 is a top surface of the slot 21, and the biometrics sensor 30 is disposed in the slot 21.

The biometrics sensor 30 is kept in hermetic contact with the unexposed surface 24 of the slot 21 through an adhesive 40. Alternatively, the unexposed surface 24 of the slot 21 is made of a flexible material.

FIG. 3 shows a modification of FIG. 2. As shown in FIG. 3, the module 20′ of the electronic apparatus of this embodiment includes a lower base 25 and an upper base 27. The lower base 25 has a through hole 26. The upper base 27 is disposed on the lower base 25. The upper base 27 and the through hole 26 of the lower base 25 form the slot 21.

The electronic apparatus of this embodiment further includes a display 50, mounted on the body 10, for displaying information. In addition, the electronic apparatus may further include a plurality of buttons 60, mounted on the body 10, so that a user can input messages through the buttons 60.

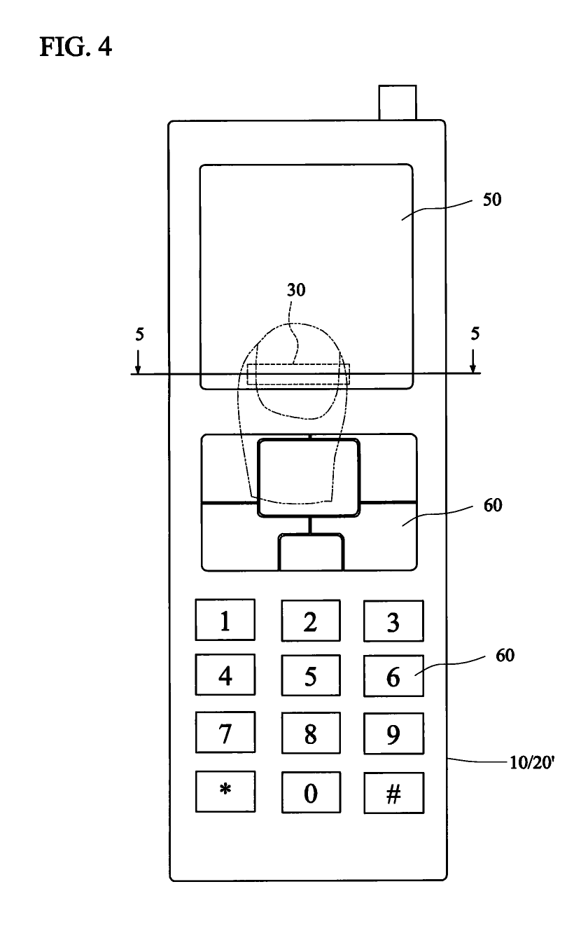

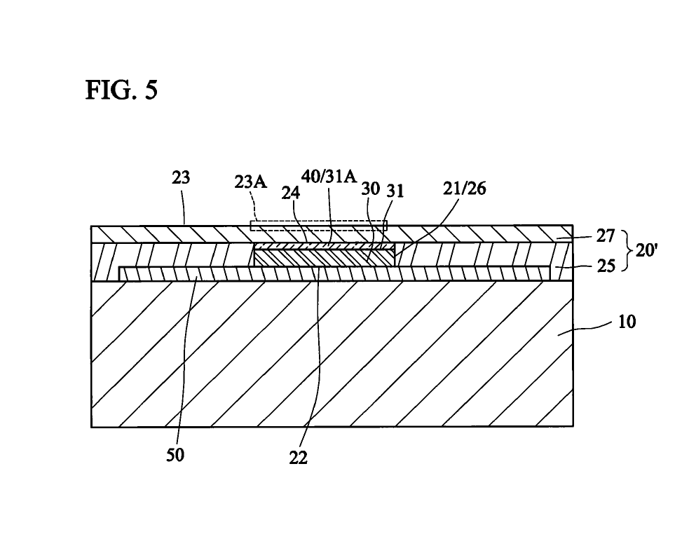

FIG. 4 is a top view showing an electronic apparatus with a hidden biometrics sensor according to a second embodiment of the invention. FIG. 5 is a cross-sectional view taken along a line 5-5 of FIG. 4. As shown in FIGS. 4 and 5, the second embodiment is similar to the first embodiment except that the biometrics sensor 30 is disposed on the display 50 including, without limitation to, a liquid crystal display (LCD). Herein, the module 20/20′ of this embodiment is an upper cover of the display, which is usually made of, without limitation to, glass. The biometrics sensor 30 is disposed under the exposed glass surface.

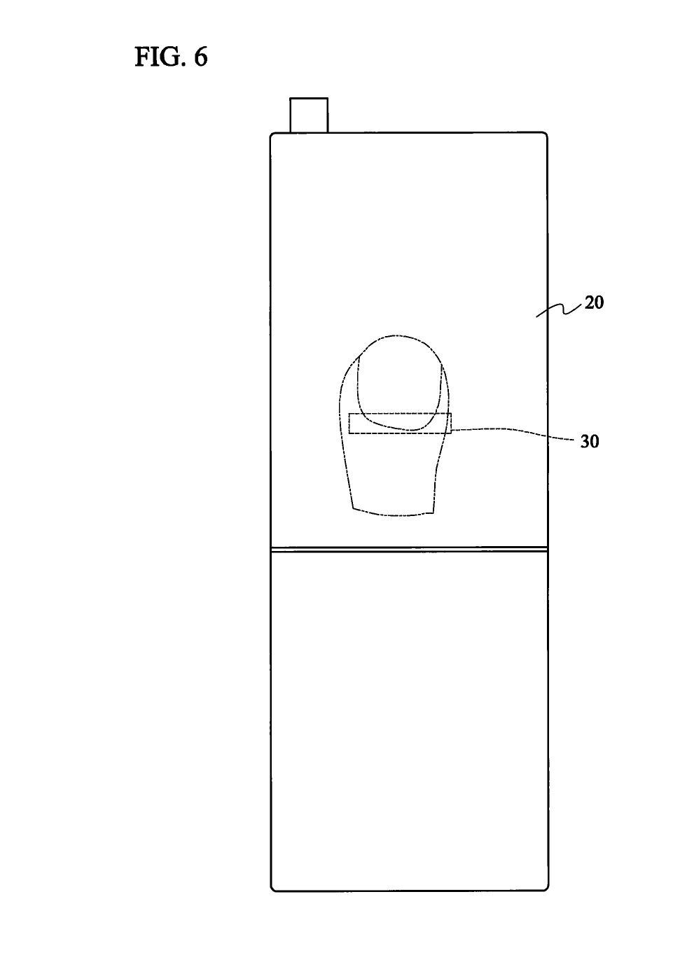

FIG. 6 is a rear view showing an electronic apparatus having a hidden biometrics sensor according to a third embodiment of the invention. In this embodiment, the module 20 is a rear cover.

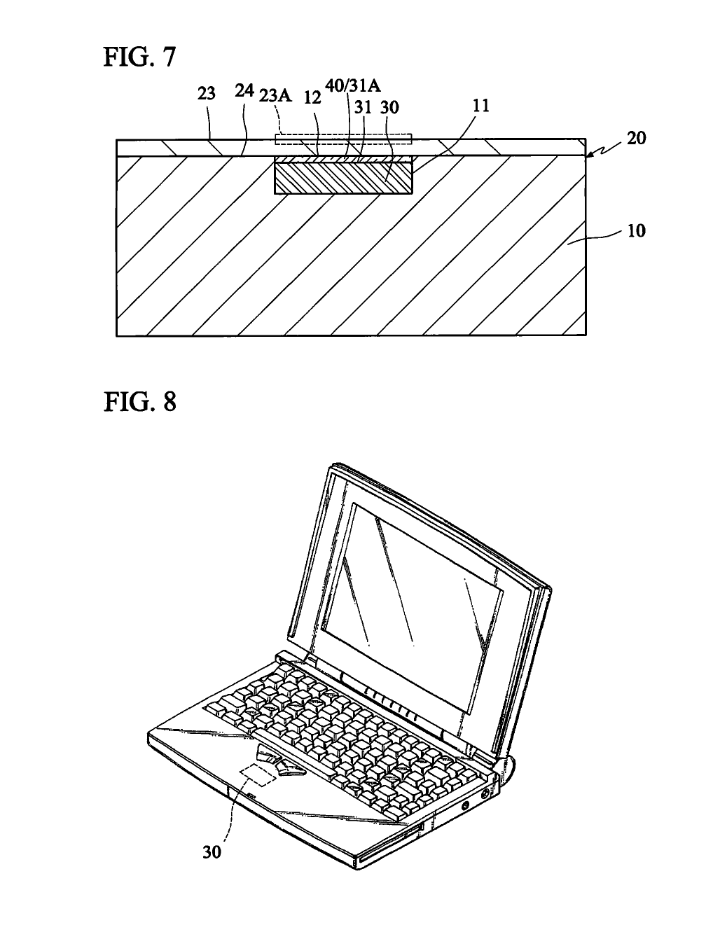

FIG. 7 shows another modification of FIG. 2. As shown in FIG. 7, what is different from FIG. 2 is that the slot is formed in the body. Therefore, the body 10 has a slot 11, which has one opening 12 disposed opposite the module 20. The biometrics sensor 30 is disposed in the slot 11.

FIG. 8 is a rear view showing an electronic apparatus having a hidden biometrics sensor according to a fourth embodiment of the invention. In this embodiment, the electronic apparatus is a notebook computer.

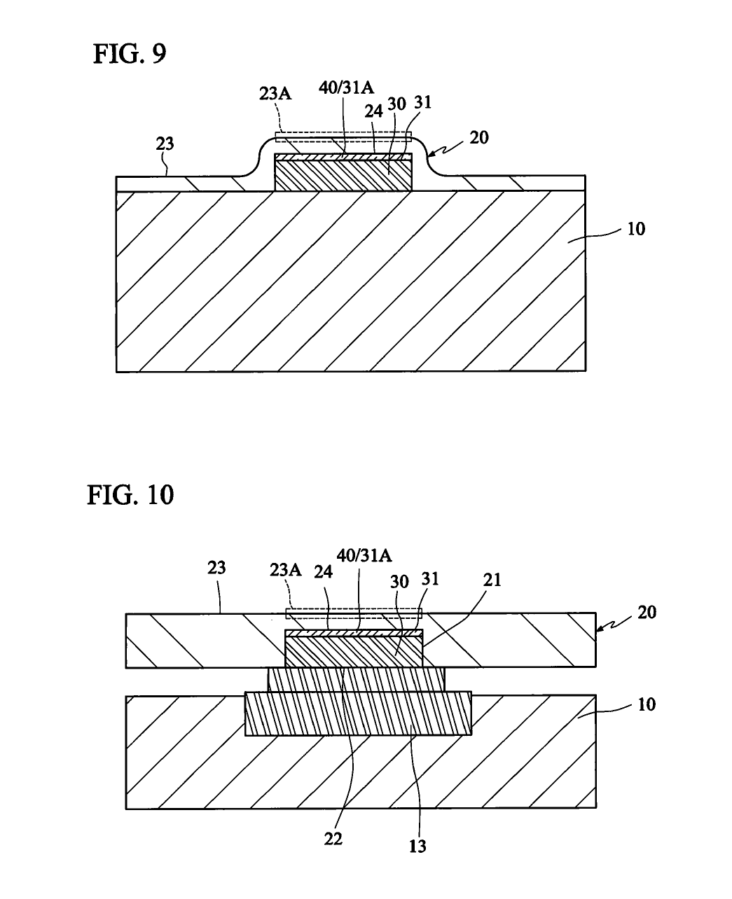

FIGS. 9 and 10 show other modifications of FIG. 2. As shown in FIG. 9, the exposed sensing surface 23A is a portion projecting beyond the exposed surface 23. In this case, the module 20 needs not to have a slot, and may be in direct surface contact with the unexposed surface 24 of the biometrics sensor 30. At this time, the biometrics sensor 30 appears to be a projection.

As shown in FIG. 10, the body 10 has a movable member 13. The biometrics sensor 30 is mounted on the movable member 13, which may be a button switch. Thus, when the finger applies a vertical force thereto, the button switch may have another function of pressure triggering for turning on or off the electronic apparatus, for example.

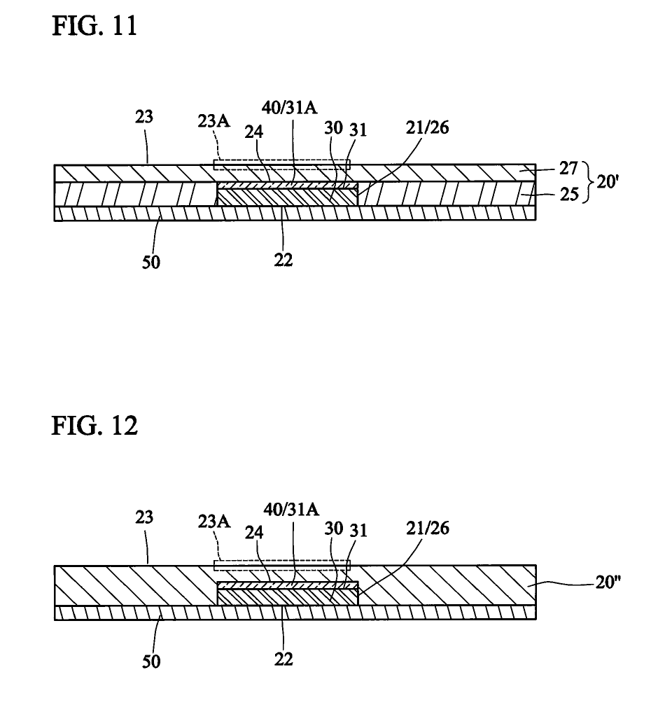

FIG. 11 is a cross-sectional view, similar to FIG. 5, showing an electronic apparatus having a hidden biometrics sensor according to a fifth embodiment of the invention. In this embodiment, the electronic apparatus includes a module 20′, a biometrics sensor 30 and a display 50 for displaying information. The module 20′ is mounted on the display 50. The module 20′ preferably has a highly transparent property. Such an electronic apparatus may also be sold as a product. The display 50 may also serve as the body of the embodiment.

FIG. 12 is a cross-sectional view, similar to FIG. 5, showing an electronic apparatus having a hidden biometrics sensor according to a sixth embodiment of the invention. This embodiment is similar to the fifth embodiment except that the module 20″ has a one-piece molded structure. The display 50 may include two pieces of glass substrates and a liquid crystal layer disposed between the two pieces of glass substrates. Alternatively, the module 20″ may be one piece of glass substrate, and the display 50 may include one piece of glass substrate and one liquid crystal layer disposed between the glass substrates of the module 20″ and the display 50.

In summary, the electronic apparatus with the hidden biometrics sensor according to the invention can simplify the structure of the casing of the electronic apparatus so that the overall electronic apparatus has the good ID outlook. In addition, the biometrics sensor is no longer exposed outside, and cannot be easily damaged by the impact and the electrostatic discharge. Furthermore, no exposed gap is formed between the biometrics sensor and the casing so that the contamination cannot be left in the gap.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An electronic apparatus, comprising:
a module having an exposed surface and an unexposed surface; and
a biometrics sensor having an embedded sensing surface joined to the unexposed surface of the module so that a portion of the exposed surface corresponding to a contact portion between the embedded sensing surface and the unexposed surface serves as an exposed sensing surface for sensing biometrics information.

2. The electronic apparatus according to claim 1, further comprising:
a body, wherein the module is mounted on the body.

3. The electronic apparatus according to claim 2, wherein the exposed surface is a fully flat surface or a substantially flat surface.

4. The electronic apparatus according to claim 2, wherein the module further has a slot, an opening of the slot is disposed opposite the body, the unexposed surface is a top surface of the slot, and the biometrics sensor is disposed in the slot.

5. The electronic apparatus according to claim 4, wherein the biometrics sensor is in contact with the unexposed surface through an adhesive.

6. The electronic apparatus according to claim 4, wherein the top surface of the slot is made of a flexible material.

7. The electronic apparatus according to claim 4, wherein the module is a one-piece molded cover.

8. The electronic apparatus according to claim 4, wherein the module comprises:
a lower base having a through hole; and
an upper base disposed on the lower base, wherein the upper base and the through hole of the lower base form the slot.

9. The electronic apparatus according to claim 2, further comprising:
a display, mounted on the body, for displaying information.

10. The electronic apparatus according to claim 9, wherein the biometrics sensor is disposed on the display.

11. The electronic apparatus according to claim 2, further comprising:
a plurality of buttons mounted on the body, wherein a user inputs messages through the buttons.

12. The electronic apparatus according to claim 2 being a mobile apparatus.

13. The electronic apparatus according to claim 2 being a notebook computer.

14. The electronic apparatus according to claim 2, wherein the body has a slot, an opening of the slot is disposed opposite the module, and the biometrics sensor is disposed in the slot.

15. The electronic apparatus according to claim 2, wherein the biometrics sensor is a fingerprint sensor.

16. The electronic apparatus according to claim 2, wherein the exposed sensing surface is a portion projecting beyond the exposed surface.

17. The electronic apparatus according to claim 2, wherein the body has a movable member, and the biometrics sensor is mounted on the movable member.

18. The electronic apparatus according to claim 17, wherein the movable member is a button switch.

19. The electronic apparatus according to claim 1, further comprising:
a display for displaying information, wherein the module is mounted on the display.

20. The electronic apparatus according to claim 2, wherein the body is a display for displaying information.
